(19) United States
(12) Patent Application Publication
(10) Pub. No.: US 2025/0055106 A1
(43) Pub. Date: Feb. 13, 2025

(54) FORM-LOCKING STRUCTURAL MEMBERS FOR BATTERY ENCLOSURE

(71) Applicant: BRIDGESTONE AMERICAS, INC., Nashville, TN (US)

(72) Inventors: Mark W. Brandley, Nashville, TN (US); Denis Schmitz, Munchen (DE); Inigo Echeto, Munchen (DE); Markus Freiberger, Munchen (DE); Adam J. Halsband, Munchen (DE); Paul M. Hannibal, Munchen (DE)

(21) Appl. No.: 18/719,515

(22) PCT Filed: Dec. 13, 2022
(86) PCT No.: PCT/US2022/081442

§ 371 Date: Jun. 13, 2024

Related U.S. Application Data
(60) Provisional application No. 63/290,318, filed on Dec. 16, 2021.

(51) Int. Cl. H01M 50/242; H01M 50/224; H01M 50/249; H01M 50/262; H01M 50/28; H01M 50/282

(52) U.S. Cl. CPC H01M 50/242; H01M 50/224; H01M 50/249; H01M 50/262; H01M 50/28; H01M 50/282

(57) ABSTRACT

A molded composite battery enclosure containing top and bottom composite covers having a formed cross member arranged between the top and bottom covers. The cross member is a formed member having a bottom portion shaped to accommodate interior surface features of the bottom composite cover. The cross member contains a flange portion for attaching to an interior surface of a battery enclosure. The flange portion of the cross member is split into separate sections to adapt to an interior surface contour of the top composite cover and an interior surface contour of the bottom composite cover.

### TECHNICAL FIELD

The present disclosure relates to structural composites for use as battery enclosures and, in particular, to structural composites having interlocking cross members for use as a battery enclosure for electric vehicles or equipment.

### BACKGROUND

Vehicles powered by electric batteries have grown in popularity with users. These vehicles allow a user the ability to charge the batteries at their place of residence or at a charging station and avoid the cost of purchasing gasoline. To supply the power needed to reach long distances, these vehicles need large capacity batteries. However, these large capacity batteries pose an increased risk to occupants and emergency responders if the batteries are damaged during a collision. The batteries need to be protected from the force generated during the collision or alternatively, any force transmitted to the batteries must be low enough so as not to cause significant damage to the batteries.

The present disclosure provides battery enclosures that are strong and light weight, as compared to battery enclosures known heretofore. The enclosures utilize composite materials, optionally with form-locking members, to protect the batteries from significant damage during a collision and assist in the assembly of the enclosures during manufacturing. The composite materials and form-locking members provide a medium for selectively improving the performance of intersecting components of a multi-component battery enclosure.

### SUMMARY

In a first aspect, disclosed is a composite battery enclosure that includes a molded top composite cover with an interior surface and an outer surface; a molded bottom composite cover having an interior surface and an outer surface, the interior surface includes a raised section that extends inward to an open storage area of the battery enclosure; and a formed cross member with a top, the top having a top surface, a base, the base having a first base section, a second base section and a third base section, the third base section positioned between the first base section and the second base section, wherein the raised section of the interior surface of the molded bottom composite cover is positioned in the third base section; and a body, the body positioned between the top and the base.

In a second aspect, there is a composite battery enclosure that includes a molded top composite cover with an interior surface and an outer surface; a molded bottom composite cover with an interior surface and an outer surface, the interior surface having a first recessed portion and a second recessed portion; and a formed cross member that includes a top having a top surface; a base, the base having a first base section, a second base section and a third base section, the third base section positioned between the first base section and the second base section, wherein the first base section is arranged in the first recessed portion of the molded bottom composite and the second base section is arranged in the second recessed portion of the molded bottom composite; and a body, the body positioned between the top and the base.

In a third aspect, there is a composite battery enclosure that includes a molded top composite cover having an interior surface and an outer surface, a molded bottom composite cover having an interior surface and an outer surface; and a formed cross member that contains a top, the top having a top surface, a base, a body, the body positioned between the top and the base; and a flange, the flange connected to the body of the formed cross member, wherein the flange is attached to an interior surface of the molded top composite cover, an interior surface of the molded bottom composite cover, or a combination thereof.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments. Directional terms as used herein—for example, up, down, right, left, front, back, top, bottom—are made only with reference to the figures as drawn and are not intended to imply absolute orientation.

### BRIEF DESCRIPTION OF THE DRAWINGS

The above and other features, examples and advantages of aspects or examples of the present disclosure are better understood when the following detailed description is read with reference to the accompanying drawings, in which:

FIG. 1 shows a cross-section view of a portion of a multi-piece battery enclosure including a molded upper composite cover and a molded bottom composite cover with a formed cross member therebetween.

FIG. 2 shows a cross-section view of a portion of a multi-piece battery enclosure including a molded upper composite cover and a molded bottom composite cover with a formed cross member therebetween.

FIG. 3 shows a perspective view of a cross member for a battery enclosure having one end including a flange for attaching to an interior surface of a battery enclosure.

FIG. 4 shows a perspective view of a cross member for a battery enclosure having one end including a split flange for attaching to multiple contours of interior surfaces of a battery enclosure.

FIG. 5 shows a cross-section view of a portion of a multi-piece battery enclosure including a molded upper composite cover and a molded bottom composite cover with a formed cross member therebetween. The formed cross member has a split flange with sections arranged against an interior surface of the molded upper composite cover and the molded bottom composite cover.

### DETAILED DESCRIPTION

The terminology as set forth herein is for description of the embodiments only and should not be construed as limiting the invention as a whole.

Herein, when a range such as 5-25 (or 5 to 25) is given, this means preferably at least or more than 5 and, separately and independently, preferably less than or not more than 25. In an example, such a range defines independently 5 or more, and separately and independently, 25 or less.

The terms “substantial,” “substantially,” and variations thereof as used herein are intended to note that a described feature is equal or approximately equal to a value or description. For example, a “substantially planar” surface is intended to denote a surface that is planar or approximately planar. It also is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The present disclosure relates to composite battery enclosures that can be used in a variety of applications. For example, the composite battery enclosures can be used to house battery systems and related accessories for mechanical equipment and in automotive applications (e.g., passenger vehicle, car, truck, bus, tractor, all-terrain vehicle). In some embodiments, the composite battery enclosure can house a battery system for electric and hybrid vehicles. The composite battery enclosure can be modular and contain multiple pieces connected or attached to one another to form a complete enclosure or box.

The composite battery enclosures can generally have increased global stiffness that resists bending and torsion of the structure and are relatively lightweight. In one or more embodiments, the composite battery enclosures can have connection or attachment areas between the top and bottom covers to provide crash strength and integrity. The composite battery enclosures can have a cover with a multi-thickness composite structure in combination with cross members arranged therewith for attributing to improved assembly of the enclosure and increased lateral stiffness of the enclosure. In another example, the composite battery enclosures can have multiple cross members positioned between composite covers that lock into a portion of the cover to further contribute to improved assembly and lateral stiffness of the enclosure.

Other advantages of the composite battery enclosures covers and cross members are that they include being easily formable into a desirable shape by conventional molding methods. For composite covers the methods can preferably use low or moderate pressure and heat, which advantageously lowers time and cost to manufacture the structures. Cross members can be roll formed members made from a bendable sheet material or a combination of materials that can be joined together, for instance, by welding, an attachment or adhesive.

The individual components (e.g., composite, formed) can be attached to one another by conventional methods, for example, using an adhesive or epoxy, a fastener (e.g., screw, bolt, clip), welding, a sealing material, or a combination thereof. For a chemical bond or attachment means between components of the battery enclosure, any suitable adhesive can be used, for example, an epoxy. For example, the adhesive can be applied to an outer surface of a composite cover, such as an exposed surface of fiber layer or an outer perimeter flange section, or along a top or bottom base surface of a cross member. It is preferable that the composite covers and cross members are permanently or semi-permanently attached to one another to ensure structural integrity of the modular composite structure during use. Other fasteners or attachment fixtures can be used in place of an adhesive, for example, a screw, snap fitting, rivet, clamp, bolt or clip. Additional local inserts or onserts can be provided at attachment locations to provide increased stiffness beyond that provided by the improved connection points of the top and bottom covers of the battery enclosure or interfaces with the cross members.

The individual composite structures of the battery enclosure, such as a molded bottom and top composite cover, can have similar components that can be made of the same or similar materials. For example, the composite covers can have a fiber-containing layer at least partially adhered to a core structure or material, which can optionally have a select multi-thickness or regions therein, for example, at or near the connection point between the covers. The fiber layers of various individual composite covers can be made of the same or similar materials to reduce material and manufacturing costs. Similarly, when recycled materials can be substituted, for example, for fibers in the fiber layers, such materials can be used to further reduce manufacturing costs and promote sustainability.

One or more embodiments further include methods for fabricating and manufacturing individual and modular composite battery enclosures. For example, a fiber layer can be positioned or applied on a surface or multiple surfaces of a core material (e.g., a first surface) to form a blank. A second fiber layer can be positioned on a second surface of the core material. Attachment devices can optionally be positioned below or on the fiber layers, for example, in cut out areas in the fiber layers. A curable material (e.g., resin) can be sprayed, poured, spread, rolled, brushed or calendared onto the fiber layers and reinforcement fibers to coat and embed the fibers in the curable material to form a pre-form composite. Under heated conditions, the pre-form composite can be molded (e.g., in a compression or press mold or similar tooling) to form the final shape of the composite battery enclosure.

Molding conditions such as temperature and pressure can be adjusted as needed but are preferably low to moderate to reduce time and cost of manufacturing the composite battery enclosure. For example, the enclosure can be heated during molding to a temperature in the range of about 100° to about 200° C., about 110° to about 190° C., about 120° to about 180° C., or about 130° to about 160° C. In another example, the enclosure can be subjected to pressure during molding in a range of about 0.1 megapascal (MPa) to about 1 MPa, about 0.15 to about 0.8 MPa, or about 0.2 to about 0.6 MPa.

The molding process can form areas of varying thickness in the composite battery enclosure that selectively increase or reduce thickness of the core material, for instance, near a connection point, at a bend area or to form a recess, indentation, channel or groove. In the embodiments that include a honeycomb as the core material, sections of the honeycomb core can be crushed or partially crushed where thickness is reduced (e.g., at corners, edges, transition areas, recesses, channels, etc.). In one or more embodiments, it is desirable to utilize a thermoplastic material (e.g., polycarbonate) as the core material. For example, a thermoplastic core material can be melted under heated mold conditions and varying thickness can be achieved without changing the integrity of the material.

In some embodiments, the fiber layers or skins can extend past the core material and join together to form flanges void of any composite material therebetween, for example, at the perimeter of the top and bottom covers. These multilayer sections can be referred to as a monolithic portion or section as opposed to a sandwich composite that contains a core material between two fiber layers. These monolithic flanges can be formed in the molding process to any desired shape to align the flanges together, for example, to nest them together.

In one or more embodiments, the composite battery enclosure (e.g., molded covers joined together) can be trimmed and polished after being molded to remove any undesirable surface imperfections, for example, a burr or raised edge or piece of material left on the structure before coupling to another battery enclosure composite piece. Burrs or imperfections can be manually or mechanically removed, for instance, mechanically grinding or sanding the surface of the composite cover. Subsequent to a trimming step, if needed, the composite covers can be cleaned to remove debris or any excess material from the surface. Cleaning can be carried out with conventional methods, for example, pressurized gas or air can be blown on the composite covers to dislodge debris, such as dust or particles, that is adhered to the surface. The composite covers can also be brushed or wiped to remove unwanted material. In another example, the covers can be brought into contact with a cleaning solution, which can dissolve residue (e.g., release agents) from the surface of the cover. For instance, an aqueous solution with a cleaning agent (e.g., a surfactant) can be used. A cleaning solution can applied to the surface of the composite covers by any suitable method such as spraying, dipping or brushing.

The steps of trimming and cleaning prepare the composite battery enclosure for downstream processes if desired. In some embodiments, the composite battery enclosure can have additional coatings applied to its surface, such as an overcoat or protective coating (a fire, smoke and toxicity (FST) material, fire-retardant material or resin). In other embodiments, the composite battery enclosure can be painted for its final application, for example, installation in an electric or hybrid vehicle. In one or more embodiments, cross members or portions thereof can be made with metal plates joined together, for instance, by welding.

Other components of the battery enclosure like cross members can be formed by different methods and materials as compared to the composite components. Cross members can be formed by rolling or forming material into a desired shape. For example, material in sheets can be cut to size and roll formed and bent into an end shape to form the cross member or a portion thereof. Sheet material can be a metal (aluminum, alloys, high-strength steel, etc.) having a thickness that provides flexibility for bending into a desired shape while also thick to provide stiffness and structural integrity to the battery enclosure. The cross-sectional geometry, material type selections, and material thickness within the cross-sectional profile of the crossmember and its component may be configured for the specific use or desired performance characteristics of the member, for example, the cross member weight, load capacity, or impact performance.

By roll forming the cross member or a portion thereof, walls of the cross member are integrally connected with adjacent walls along with being made from the same sheet material. The body of the cross members lends to roll forming methods, whereas the flanged ends can also be roll formed or include end features connected or attached to the cross member body. By attaching end flange components to the axial ends of the cross member, the cross member body may be cut in a plane that is perpendicular to the longitudinal axis of the cross member, which can be easily accomplished in-line on a roll former. In other embodiments, other materials can be used to form the cross members, for example, plastics that can be formed in a mold. Various cross-sectional shapes may be formed for accommodating different cross member designs that provides various load performance options.

Assembly of the composite battery enclosure and related components can be carried out by positioning the bottom composite cover and then inserting the desired battery system and cross members. Battery cells can be mounted over the cooling system followed by connection of all electrical cables. If desired, a perimeter seal is positioned on the bottom composite cover before placing the top composite cover over the bottom cover. Attachment means, for instance adhesive or fixtures (e.g., screws), are used to secure the cross members, top and bottom composite covers together before mounting the assembled composite battery enclosure in the desired application such as an electric vehicle.

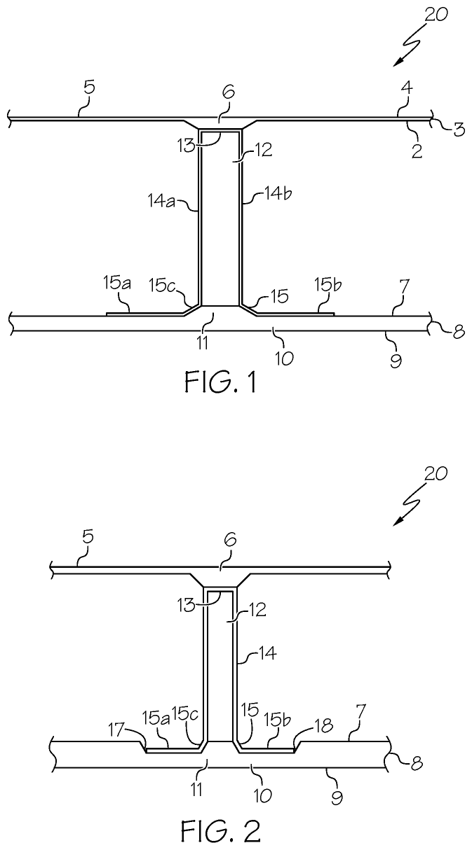

Turning to the figures, FIGS. 1 and 2 show cross-section views of a portion of a battery enclosure 20 that includes a cross member secured in position between molded top and bottom composite covers. In FIG. 1, the two-piece composite battery enclosure 20 that includes a molded top composite cover 5 and a molded bottom composite cover 10, which can be attached to one another at an interface area to provide a battery enclosure area. The covers 5, 10 can be attached to one another to house a battery system including a plurality of batteries. Any suitable number of batteries can be included in the battery enclosure 20, for instance, for accommodating an electric vehicle power requirement. Enclosure 20 can be a component of a vehicle such that enclosure is secured to other portions or parts of a vehicle, for example, a frame structure. Top and bottom composite covers 5, 10 have core sections 3, 8 arranged between two skins 2, 4, 7, 9 (e.g., fiber layers). The core sections can extend in a central area of a cover 5, 10 along its entire length as shown and further include portions having an increased thickness at select regions, for example, along a perimeter edge for providing impact protection, stiffness to the battery enclosure, and resistance to shifting of the covers. In one or more embodiments, the core sections 3, 8 can include sections of increased thickness, such as a ridge, for supporting and interlocking cross members arranged between the covers 5, 10.

For the core sections of the covers disclosed herein, for example cores 3, 8 of the individual composite covers, the core material can be a plurality of open or gas-filled cells defined by cell walls. The cells can have any suitable cross-section shape (e.g., circular, hexagon, square, etc.). For example, the cores can be a honeycomb structure that includes many individual open cells side by side and arranged in the composite structures such that the cell walls are perpendicular to the longitudinal axis of the composite structure or an adjacent fiber layer. Alternatively, the cell walls can be arranged at other angles, for example, parallel or angled relative to the longitudinal axis of the composite structure. The cell walls can be made of plastic, for example, a thermoplastic or thermoset material. In one example, polypropylene or polycarbonate can be used as the material for the core and/or cell walls. The plurality of cells can be molded to form a desired shape wherein a portion of the cells are deformed under pressure, and optionally heat, to reduce the initial thickness of the core material.

In one or more embodiments, the cores can be a non-cell material and composed any suitable thermoplastic material. Examples of thermoplastic materials include, but are not limited to, polypropylene and polycarbonate. The thermoplastic core can be a solid structure without openings such as cells. The thermoplastic core material can be molded under moderate heat and pressure to soften the material and form it into the desired shape having varying thickness. In one example, the thermoplastic material is heated above its glass transition temperature in a molding process to form the desired shape of the structure. The thermoplastic material can be heated, for example in a mold, to have a temperature in the range of about 100° to about 200° C., about 110° to about 190° C., about 120° to about 180° C., or about 130° to about 160° C. After forming the desired structure shape of the core, the thermoplastic material can be cooled to room temperature. In one or more embodiments, the average thickness of the core can be in the range of about 5 to about 250 millimeters (mm), about 5 to about 100 mm, or about 10 to about 50 mm.

The core is preferably easily moldable to arrive at the desired shape for the composite covers. In one or more embodiments, the core can have regions of different thicknesses and angles along its length (e.g., the area of increased thickness 6, 11). The core material can have properties that provide an energy absorbing and insulating abilities. For example, the core can be a low density, crushable core that deforms upon impact and yet retains mechanical integrity (e.g., stiffness) in normal operation. The open cells and cell walls of a honeycomb core can absorb impact energy as the cell walls collapse and break. Other materials that can absorb energy can include elastomers, thermoplastic material, foams (e.g., open cell, viscoelastic, etc.), paper (e.g., cardboard), or molded resins. These materials can be combined with the plurality of cells, for example, the cells or a portion thereof (e.g., select regions where impact or insulating is desired) can be filled or partially filled with foams or elastomers. In other embodiments, the core material can reduce conductivity as compared to other conventional materials such as steel. In one or more embodiments, the core materials of the composite structures of the present disclosure can include a conducting fiber (e.g., electrical conducting) for providing electromagnetic compatibility properties or behavior of the composite structure. For example, conductive reinforcements (e.g., metal inlay) or conductive wires can be layered in the sandwich composites or woven in fiber layers of the top and bottom composite covers 5, 10. In another example, shielding foil such as aluminum foil or an outer shielding layer such as metal (e.g., copper) veil can be applied to the battery enclosure 20.

Top composite cover 5 has a top skin 4 that forms an outer surface facing the environment surrounding the enclosure and a bottom skin 2 that forms an interior surface that faces the battery enclosure area for storing batteries. Top skin 4 and bottom skin 2 can include a core material 3 sandwiched therebetween and in direct contact with the skins. Bottom composite cover 10 has a top skin 9 that forms an outer surface facing the environment surrounding the enclosure and a bottom skin 7 that forms an interior surface that faces the battery enclosure area for storing batteries, which sandwich core material 8 therebetween that is in direct contact with the skins. In one or more embodiments, the skins 2, 4, 7, 9 can be a fiber layer. A fiber layer can contain continuous and/or discontinuous fibers embedded in a polymer material to form layers having a substantially uniform thickness. The fibers can be arranged together to form a sheet or mat that can be positioned on a core material.

The fibers can be entangled in a random pattern or in a more systematic design, for example, the fibers can be unidirectional/aligned or weaved together in the form of a woven fiber sheet. In other examples, the fibers can be loosely bundled together or pressed together into a mat to form a fiber sheet. Multiple layers of unidirectional fibers can be used, for example, each layer of unidirectional fibers can be arranged at a parallel, angled or perpendicular position relative to an underlying fiber layer. A whole fiber sheet can be used to cover a core material surface (e.g., a top surface). Alternatively, strips or sections of fibers can be applied side by side in a segmented arrangement to cover a core material surface. Examples of fibers that can be used in the fiber layer include carbon fibers, glass fibers, plastic fibers, etc. In one example, an inexpensive fiberglass sheet can be applied to a first surface of a core material.

The fibers can be applied to the surface of a core material to cover an entire face surface of the core material or a portion thereof. In some embodiments, the fibers are arranged on a core material, a polymer forming material or resin can be applied onto the fibers. The polymer forming material can penetrate and soak into the fibers arranged on the core material, which can embed or partially embed the fibers in the polymer forming material. As described herein, polymer forming material can be pushed and forced into the fiber layer to embed the fibers during a molding step, for example, a press or compression mold can push polymeric resin into the fibers to coat the fibers, fill voids in the fiber layer and contact the core material. A sufficient amount of polymer forming material can be applied to the fibers to form polymer layer that embeds the fibers and contacts the core material 3, 8 to adhere the fibers to one another and to the core. In one or more embodiments, the polymer can be formed from a curable polymer resin or composition. The composition can include a mixture of components, for example, a thermoset material, a thermoplastic material, a hardener, a catalyst, fillers, and any combination thereof. Materials can include epoxy, polyurethane, polyether ether ketone, polyethylene, or combinations thereof. The composition preferably has a low cure period in the range of 1 to 20 minutes, or less than 15, 10 or 5 minutes. The polymer forming material once cured can bond the fiber layer (e.g., 2, 4, 7, 9) to the core material (e.g., 3, 8) to form a laminate as the composite structure (e.g., 5, 10). The fiber layer preferably bonds or adheres to the core to prevent delamination or separation of the fiber layer from core material.

As applied to a fiber layer or core material, a curable material can be applied onto the fiber reinforcement region or regions if present. The curable material can be the same curable material used to embed the fibers of the fiber layers. For instance, materials can include a mixture of components, for example, a thermoset material, a thermoplastic material, a hardener, a catalyst, fillers, and any combination thereof. Curable materials can include epoxy, polyurethane, polyether ether ketone, polyethylene, or combinations thereof. The curable material (e.g., resin) can be sprayed, poured, spread, rolled, brushed or calendared onto the fiber reinforcement region to embed or the fibers in the curable material to form a pre-form composite. Under heated conditions, the pre-form composite can be molded (e.g., in a compression) mold to form the final shape of the composite structure.

In one or more embodiments, the top composite cover 5 can include a section of increased thickness 6 at select areas for supporting a cross member, for example, the top surface 13 of a cross member 12. The section of increased thickness 6 can be in the form of a support ridge that extends inward to the battery enclosure area. The support ridge 6 has a flat surface for contacting the top surface 13 of the cross member 12. In one example, the support ridge 6 has a width and length that is the same or substantially similar to the top surface dimensions of the cross member. In another example, the section of increased thickness 6 can be separate spots spaced out along the interior surface 2 of the top composite cover 5 to support sections of the cross member 12. The spots can have any suitable form, for instance, round or square raised sections having dimensions that are similar to the width of the top surface of the cross member. In other embodiments, the section of increased thickness 6 of the top composite cover 5 can be positioned opposite a second section of increased thickness or a raised area on the interior surface 7 of the bottom composite cover 10.

As shown in FIG. 1, the bottom composite cover 10 can include a section of increased thickness or a raised section 11 at select areas for supporting a cross member, for example, the base 15 of a cross member 12. The section of increased thickness 11 can be in the form of a support ridge that extends inward to the battery enclosure area. The support ridge 11 has a flat surface for contacting the top surface 13 or fitting in recessed section of the base 15 of the cross member 12. In one example, the support ridge 11 has a width and length that is the same or substantially similar to the top surface or recessed base section dimensions of the cross member. In another example, the section of increased thickness 11 can be separate spots spaced out along the interior surface 7 of the bottom composite cover 10 to support sections of the cross member 12, for instance, the base 15. The spots can have any suitable form, for instance, round or square raised sections having dimensions that are similar to the width of the top surface or recessed based section 15c of the cross member. As shown, the raised section 11 is positioned opposite the increased thickness section 6 of the top composite cover. For accommodating multiple cross members, not shown, the top and bottom composite covers 5, 10 can have a plurality of sections of increased thickness positioned at areas for placement of the cross members.

Positioned between the sections of increased thickness as shown in FIGS. 1 and 2 is a cross member 12. The cross member 12 has a top 13 with a top surface, a body 14, and a base 15. The body 14 has two sides 14a, 14b and an open center area for reducing the weight of the cross member. As shown, the cross member 12 has an open cross section with an access opening in the base 15 area to the open center area or cavity of the body 14. The top 13 provides a closed end to the body 14. The base 15 can be defined by three sections. First base section 15a extends outward from body 14, for example, in a flat plane. The first base section 15a provides stability to the cross member 12 on one side and can rest against the interior surface 7 of the bottom composite cover 10. In certain embodiments, the first base section 15a can be attached to the interior surface 7 of the bottom composite cover 10, for instance, with an adhesive or fastener.

Opposite the first base section 15a is a second base section 15b. Second base section 15b extends outward from body 14, for example, in a flat plane and rests against the interior surface 7 of the bottom composite cover 10. The second base section 15b, like the first base section 15a, can be attached or in direct contact with the interior surface 7 of cover 10. In one or more embodiments, the first base section 15a can be the same or mirror image of the second base section 15b. Together the first and second base section 15a, 15b stabilize the cross member 12 from shifting or bending laterally.

Positioned between the first and second base sections 15a, 15b is a third base section 15c. The third base section 15c connects the bottom of body 14 to the base 15 of the cross member 12. The third base section 15c, as shown, has sides that extend upward from sections 15a, 15b and section 15c is open and provides access to the open cavity area of the body 14 of the cross member 12. The raised sides of the third base section 15c, as compared to the first and second sections 15a, 15b, forms a recess area for housing the raised section 11 of the bottom composite cover 10. In an example, FIG. 1 shows the raised section 11 positioned inside the third base section 15c. The raised sides of the third base section 15c rest against and contact the sidewall areas of the raised section 11 to secure the cross member 12 in place over section 11. The sides of base section 15c and raised section 11 can be any desired shape and are illustrated as angled surfaces.

As shown, the raised section 11 fills the opening formed by third base section 15c of the cross member 12 such that the open cavity area of body 14 is closed off and not accessible. The top portion of the raised section 11 is flat and has substantially the same width as the open cavity area of body 11. In certain embodiments, the sides of the third base section 15c can be attached to a surface of the raised section 11 of the bottom composite cover 10, for instance, with an adhesive or fastener.

FIG. 2 shows another embodiment of cross member 12 being form locked with bottom composite cover 10. As shown, cover 10 has two recessed portions 17, 18. The interior surface 7 of the bottom composite cover 10 is substantially flat with a continuous linear plane surrounding the recessed portions 17, 18 that extend downward towards the exterior surface 9 of the cover 10. The recessed portions, first portion 17 and second portion 18, have a central section that accommodates a base section of the base 15 of the cross member 12. The first recessed portion can be the same shape and have the same dimensions as the second recessed portion in the instance the first and second base section 15a, 15b are the same. For example, as shown, the first recessed portion 17 has flat central section for housing first base section 15a that rests against portion 17. Preferably, the entire first and second base sections 15a, 15b are respectively housed or positioned in the first and second recessed portions 17, 18 to reduce movement of the cross member 12 in the battery enclosure. In certain embodiments, the first and second base sections 15a, 15b can be attached to a surface of the recessed portions 17, 18 of the bottom composite cover 10, for instance, with an adhesive or fastener to secure the base of the cross member 12 to cover 10.

The first recessed portion 17 is separated from the second recessed portion 18 by raised section 11, wherein raised section 11 is positioned in the third base section 15c. In one embodiment, raised section 11 extends upward from the recessed portions 17, 18 and has a top surface flush with the interior surface 7 on the side of either recessed portion. In other examples, the raised section 11 can extend above the interior surface 7 of cover 11 adjacent the side of either recessed portion 17, 18. Preferably section 11 of cover 10 is attached to third base section 15c, for example, with an adhesive or epoxy to secure the cross member 12 to cover 10.

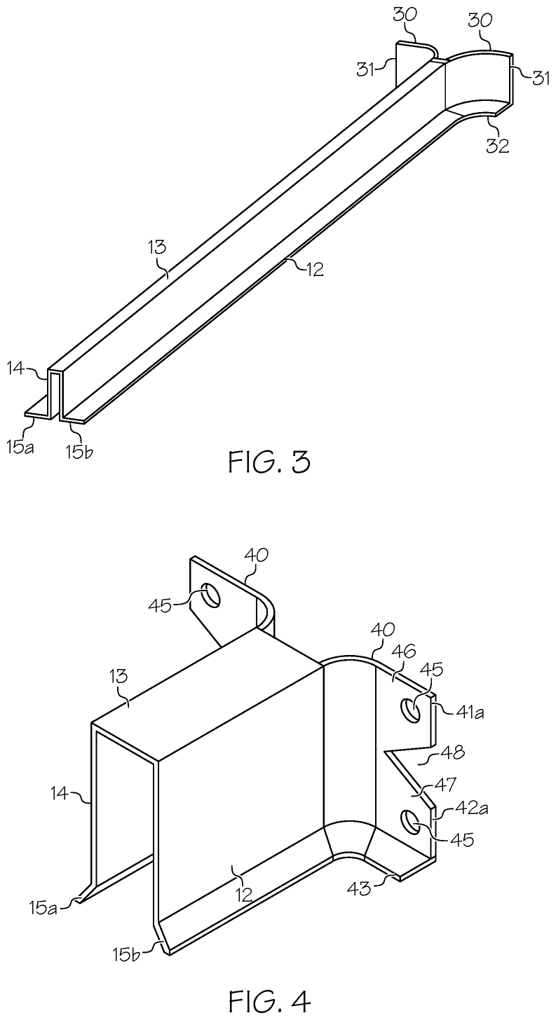

FIGS. 3-5 show various embodiments of cross member 12 having flanges 30 connected primarily to the body 14 of the member 12. In one or more embodiments, flange 30 can be prepared as an integral portion of member 12, for instance, in a roll formed method. In other embodiments, flange 30 can be formed and separately attached to an end of cross member 12, for example, by welding. Materials for forming flange 30 include those suitable for cross member 12. In an example, the same material, such as a sheet metal, is used to form both cross member 12 and flange 30.

As generally positioned in a battery enclosure, cross member 12 has ends, excluding any flanges, that have a centerline that terminates perpendicular at the sidewall of the enclosure formed by one or more covers 5, 10. FIG. 3 shows a flange 30 extending from both walls of body 14 of member 12, the flange 30 extending away from body 14 in a curved shape that terminates at the ends 31 of the flanges. The flange ends 31 are positioned outside the width of the body 14 and base section 15 of member 12. Flanges 30 can extend outward and perpendicular to the centerline of body 14 in shapes other than curved, for example, in a 90 degree angle or a series of angled sections such that a mounting portion is formed that can accommodate the plane of a sidewall (e.g., interior surface of covers 5, 10) of the battery enclosure. The curved shape of the flanges transitions into a mounting portion that is preferably substantially perpendicular to the body 14 length or centerline of the member 12 such that the mounting portions can fit against sidewalls of the battery enclosure. As shown, the mounting portions of the flanges can curve and transition into a parallel plane with one another for mounting onto a sidewall that can be positioned in a more perpendicular plane as compared to the centerline of body 14. That is, the flanges are designed to curve and form a portion that can be arranged parallel to the sidewalls of the enclosure for attaching the flanged ends of the cross member 12 to the sidewalls of the enclosure.

The flanges 30 can further include, optionally, a base section 32 that connects to the base 15 of member 12. The base section 32 can be made of the same material as the remaining portions of the flange 30, which can further be the same as the material for cross member 12. The base section 32 can be roll formed as part of flange 30 or, alternatively, be separately assembled and attached to the body of flange 30. As shown in FIG. 3, the base section 32 of flange 30 is curved and substantially follows the curved profile shape of flange. In an example, the base section 32 of flange 30 is a flat section that is positioned in the same plane as the first or third base sections 15a, 15b of member 12. In other embodiments, the base section 32 of flange 30 is formed to match the contour of the sidewall portion it abuts on the sidewall or corner area of the battery enclosure. The base section 32 can be attached to an interior surface of the battery enclosure, for example, with an adhesive or fastener.

The flange 30 can optionally include one or more apertures for accommodating an attachment device for securing the flange to an interior surface of the battery enclosure. For example, the aperture can be any shape and size hole for fitting an attachment device, such as a fastener, screw, bolt, plug and the like. Any suitable number of apertures can be positioned in a mounting portion of a flange, for instance, 1, 2, 3, 4 or 5 apertures in a flange. FIG. 4 shows a flange 40 having two apertures 45 for mounting the cross member 12 to an interior surface of the battery enclosure.

FIG. 4 further shows another embodiment of a flange 40 for the cross member 12. The flange 40 is split at its end to form two members. The two members can be aligned and shaped, curved or formed to accommodate various geometries of interior surfaces of the battery enclosure. For example, the flange may not be positioned against a continuous flat plane that can easily be matched with a flat portion of a flange. In certain instances when a flange is positioned against a surface having an irregular shape, for various portions with different mounting planes, the flange can be split or segmented to have members to accommodate various contours of the battery enclosure. In one or more embodiments, the flange 40 can include a first flange member 46 and a second flange member 47 positioned at an end 41 of the flange. The first flange member 46 has end 41a and is separated from the second flange member 47 having end 41b. Separating the flange members 46, 47 is a gap positioned in the end of the flange between ends 41a and 41b. The gap can be any suitable shape and provide flexibility in positioning or bending the members 46, 47 at various angles and curvatures to fit against a surface contour of an interior surface of the battery enclosure. For attaching to an interior surface of the battery enclosure, the first and second members 46, 47 can include one or more apertures 45 for mounting an attachment device. The bottom or second flange member 47 can include a base section 43 as similarly described above for flange 30.

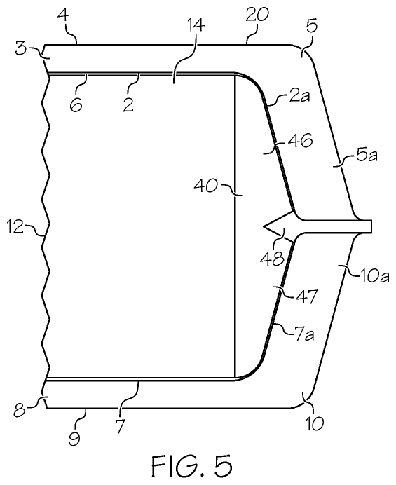

FIG. 5 shows a cross member 12 mounted to an interior surface 2a, 7a of a sidewall portion of a top and bottom composite cover 5, 10. The top composite cover 5 includes a top section or portion that forms the central top surface of the battery enclosure. A portion of the sidewalls of the battery enclosure are formed by the sidewall section 5a of the top composite cover 5. In one or more embodiments, the battery enclosure 20 can be in the shape of a square or rectangular box such that the top composite cover 5 includes up to four sidewall sections 5a connected together and formed by core material 3 sandwiched by skins 2, 4. The bottom composite cover 10 includes a bottom section or portion that forms the central bottom surface of the battery enclosure. A portion of the sidewalls of the battery enclosure are formed by the sidewall section 10a of the bottom composite cover 10. In one or more embodiments, the bottom composite cover 10 includes up to four sidewall sections 10a connected together and formed by core material 8 sandwiched by skins 7, 9. Together, the sidewall sections 5a, 10a of the top and bottom composite covers 5, 10 form the sidewalls of the battery enclosure.

As shown, the sidewalls 5a, 10a of the top and bottom covers 5, 10 interface at a midpoint along the sidewall section of battery enclosure 20 and form two different sidewall contours along interior surfaces 2a and 7a. The first flange member 46 of flange 40 is attached to the interior surface 2a of sidewall section 5a of top composite cover 5 and second flange member 47 of flange 40 is attached to the interior surface 7a of sidewall section 10a of bottom composite cover 10. The members 46, 47 of flange 40 are separated by gap 48 such that the members are angled or curved to abut interior surfaces 2a, 7a for mounting to separate sidewall contours of battery enclosure 20 to secure cross member 12 in place. To accommodate other shapes, contours and positions of interior surface configurations of sidewalls, gap 48 can be positioned at any point along the end of flange 40 to form equal or varying member sizes.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A composite battery enclosure comprising:
a. a molded top composite cover comprising
i. an interior surface and an outer surface;
b. a molded bottom composite cover comprising
i. an interior surface and an outer surface, the interior surface comprising a raised section; and
c. a formed cross member comprising
i. a top, the top comprising a top surface;
ii. a base, the base comprising a first base section, a second base section and a third base section, the third base section positioned between the first base section and the second base section, wherein the raised section of the interior surface of the molded bottom composite cover is positioned in the third base section; and
iii. a body, the body positioned between the top and the base.

2. The composite battery enclosure of claim 1, wherein the raised section of the interior surface of the molded bottom composite cover is positioned directly below the body of the base of the formed cross member.

3. The composite battery enclosure of claim 1, wherein the formed cross member comprises an open cavity in the body, the open cavity being accessible through the third base section of the base of the formed cross member.

4. The composite battery enclosure of claim 1, wherein the interior surface of the molded bottom composite cover comprising flat sections adjacent the raised section, the first base section and the second base section of the formed cross member being attached to the flat sections adjacent the raised section.

5. The composite battery enclosure of claim 1, wherein the third base section of the formed cross member extending upward from both the first base section and the second base section and a portion of the raised section of the interior surface of the molded bottom composite cover positioned above the first base section and the second base section.

6. The composite battery enclosure of claim 1, wherein the top surface of the formed cross member is attached to an interior surface of the molded top composite cover.

7. The composite battery enclosure of claim 6, wherein the interior surface of the molded top composite cover attached to the top surface of the formed cross member is a raised section for adjoining to the formed cross member.

8. A composite battery enclosure of claim 1, wherein the interior surface of the molded bottom composite cover further comprises a first recessed portion and a second recessed portion, and the first base section of the formed cross member is arranged in the first recessed portion of the molded bottom composite and the second base section of the formed cross member is arranged in the second recessed portion of the molded bottom composite.

9. The composite battery enclosure of claim 8, wherein the third base section is connected to the body of the formed cross member, and the third base section defines an opening to the body of the formed cross member.

10. The composite battery enclosure of claim 8, wherein the first base section is adhered to a surface in the first recessed portion of the molded bottom composite.

11. The composite battery enclosure of claim 8, wherein the body is formed of a metal sheet material and the first base section, the second base section and the third base section are roll formed from the same metal sheet material that forms the body of the formed cross member.

12. A composite battery enclosure comprising:
a. a molded top composite cover comprising
i. an interior surface and an outer surface;
b. a molded bottom composite cover comprising
i. an interior surface and an outer surface; and
c. a formed cross member comprising
i. a top, the top comprising a top surface;
ii. a base;
iii. a body, the body positioned between the top and the base; and
iv. a flange, the flange connected to the body of the formed cross member, wherein the flange is attached to an interior surface of the molded top composite cover, an interior surface of the molded bottom composite cover, or a combination thereof.

13. The composite battery enclosure of claim 12, wherein the flange of the formed cross member has a first flange member and a second flange member, the first flange member is attached to an interior surface of the molded top composite cover and the second flange member is attached to an interior surface of the molded bottom composite cover.

14. The composite battery enclosure of claim 12, wherein the first flange member is separated from the second flange member by a gap in an end edge of the flange.

15. The composite battery enclosure of claim 12, wherein the body of the formed cross member is attached to a second flange and the second flange is attached to an interior surface of the molded top composite cover, an interior surface of the molded bottom composite cover, or a combination thereof.

16. The composite battery enclosure of claim 12, wherein the flange comprises an aperture.

17. The composite battery enclosure of claim 12, wherein the flange is curved as it extends from the body of the formed cross member.

18. The composite battery enclosure of claim 12, wherein the body is formed of a metal sheet material and the flange is roll formed from the same metal sheet material that forms the body of the formed cross member.
